(19) United States
(12) Patent Application Publication
(10) Pub. No.: US 2009/0237373 A1
(43) Pub. Date: Sep. 24, 2009

(54) TWO WAY TOUCH-SENSITIVE DISPLAY

(75) Inventor: Per-Ragnar HANSSON, Stockholm (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/051,299

(22) Filed: Mar. 19, 2008

(51) Int. Cl. G06F 3/045; G06F 3/041

(52) U.S. Cl. 345/174; 345/173

(57) ABSTRACT

A method performed by a device having a touch-sensitive display may include displaying an image on the touch-sensitive display; detecting a touch on the touch-sensitive display; determining a type of the touch; associating a location of the touch with the image displayed on the touch-sensitive display; and generating a command signal based on the type of touch and the location of the touch on the touch-sensitive display.

### BACKGROUND

The proliferation of devices, such as handheld and portable devices, has grown tremendously within the past decade. A majority of these devices include some kind of display to provide a user with visual information. These devices may also include an input device, such as a keypad, touch screen, and/or one or more buttons to allow a user to enter some form of input. However, in some instances, the input device may limit the space available for other components, such as the display. In other instances, the capabilities of the input device may be limited.

### SUMMARY

According to one aspect, a method performed by a device having a touch-sensitive display may include displaying an image on the touch-sensitive display; detecting a touch on the touch-sensitive display; determining a type of the touch; associating a location of the touch with the image displayed on the touch-sensitive display; and generating a command signal based on the type of touch and the location of the touch on the touch-sensitive display.

Additionally, the type of touch may be one of a tap or a push.

Additionally, the touch-sensitive display may include a resistive touch panel.

Additionally, the touch may be made by a deformable object.

Additionally, determining the type of touch may include distinguishing between changing surface areas of a deformable object as the deformable object is depressed on the touch-sensitive display to distinguish a first type of the touch from a second type of the touch.

Additionally, determining the type of touch may include comparing touch coordinates registered on the touch-sensitive display over a discreet time interval.

According to another aspect, a device may include a display to display information; a touch-sensitive panel to identify a set of touch coordinates of a touch on the touch-sensitive panel; processing logic to interpret the set of touch coordinates as one of a tap or a push; processing logic to associate the touch coordinates with corresponding coordinates of the information on the display; and processing logic to generate a command signal based on the interpreted set of touch coordinates and the corresponding coordinates of the information on the display.

Additionally, the touch-sensitive panel may include a resistive touch panel.

Additionally, the touch may be made by a deformable object.

Additionally, the processing logic to interpret the set of touch coordinates as one of a tap or a push may distinguish between changing surface areas of a deformable object as the deformable object is depressed on the touch-sensitive panel.

Additionally, the processing logic to interpret the set of touch coordinates as one of a tap or a push may compare touch coordinates registered on the touch-sensitive panel over a discreet time interval.

Additionally, the touch-sensitive panel may be overlaid on the display.

Additionally, the device may further comprise a housing, where the touch-sensitive panel and the display are located on separate portions of the housing.

According to still another aspect, a computer-readable memory having computer-executable instructions may include one or more instruction for displaying an image on a touch-sensitive display; one or more instructions for detecting a touch on the touch-sensitive display; one or more instructions for identifying a location of the touch on the touch-sensitive display; one or more instructions for identifying a type of the touch; one or more instructions for associating the location of the touch and the type of the touch with the image displayed on the touch-sensitive display; and one or more instructions for generating a command signal based on the type of the touch, the location of the touch on the touch-sensitive display, and the image on the touch-sensitive display.

Additionally, the type of touch may be identified as one of a tap or a push.

Additionally, the touch-sensitive display may include a resistive touch panel.

Additionally, the touch may be made by a deformable object or body part.

Additionally, identifying a type of the touch may include distinguishing between changing surface areas of a deformable object as the deformable object is depressed on the touch-sensitive display.

Additionally, identifying a type of the touch may include comparing touch coordinates registered on the touch-sensitive display over a discreet time interval

In another aspect, a device may include means for displaying an image on a touch-sensitive display; means for detecting a touch on the touch-sensitive display; means for determining a kind of the touch; means for identifying coordinates of the touch on the touch-sensitive display; means for associating coordinates of the touch with the image displayed on the touch-sensitive display; and means for generating a command signal based on the kind of touch and the coordinates of the touch on the touch-sensitive display.

Additionally, a method performed by a device having a touch-sensitive panel may include displaying an object on a screen; identifying a first set of coordinates of a touch by a deformable object at a first time; identifying a second set of coordinates of a touch by the deformable object at a second time; associating the first set of coordinates and the second set of coordinates with the object on the screen; and generating an input signal based on the object on the screen, the first set of coordinates and the second set of coordinates.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram of an exemplary electronic device in which methods and systems described herein may be implemented;

FIG. 2 is a block diagram illustrating components of the electronic device of FIG. 1 according to an exemplary implementation;

FIG. 3 is functional block diagram of the electronic device of FIG. 2;

FIG. 4 is a diagram illustrating exemplary touch patterns on the surface of an exemplary electronic device;

FIG. 5A shows an exemplary tap touch input on the surface of a display as a function of time;

FIG. 5B shows an exemplary push touch input on the surface of a display as a function of time;

FIG. 6 is a flow diagram illustrating exemplary operations associated with the exemplary electronic device of FIG. 2; and

FIG. 7 is a diagram of another exemplary electronic device in which methods and systems described herein may be implemented.

### DETAILED DESCRIPTION

The following detailed description refers to the accompanying drawings. The same reference numbers in different drawings may identify the same or similar elements. Also, the following detailed description does not limit the invention.

### Overview

The term “touch,” as used herein, may refer to a touch of a deformable object, such as a body part (e.g., a finger) or a deformable pointing device (e.g., a soft stylus, pen, etc.). A touch may be deemed to have occurred by virtue of the proximity of the body part or pointing device to a sensor. The term “touch screen,” as used herein, may refer to a touch-sensitive screen that can detect the location of touches within a display area on the touch screen. The term “touch pattern,” as used herein, may refer to a pattern that is made on a surface by tracking a touch within a time period.

Resistive touch screens may be used in many electronic devices, such as personal digital assistants (PDAs), smartphones, portable gaming devices, media player devices, camera devices, laptop computers, etc. A previous drawback with resistive touch screen technology is that generally these types of screens can only detect one type of touch input. Implementations described herein utilize touch-coordinate-recognition techniques that distinguish between a light touch input (a “tap”) and a higher force input (a “push”). Implementations of such distinctions may provide new user interface possibilities for devices with resistive touch screens.

In implementations described herein, a touch or a single set of touches on a touch screen may be identified as a variable input signal depending on the location and type of touch. A single touch may be identified as a “tap” or a “push.” A tap may represent a different type of input signal than a push. The input signal may be utilized in a variety of different ways to facilitate a user interface for a device with a touch screen. For example, a tap may enter a program and a push may open an option menu. As another example, a tap may generally mimic a user input of a left side of a two button input device (such a computer mouse) while a push may mimic the right side button of the same device. In still another example, the tap/push distinction may be used with a virtual keyboard to differentiate between lowercase and capital letter inputs. In another example, the distinction between a tap and a push may be used to differentiate between different command functions in a gaming environment.

### Exemplary Device

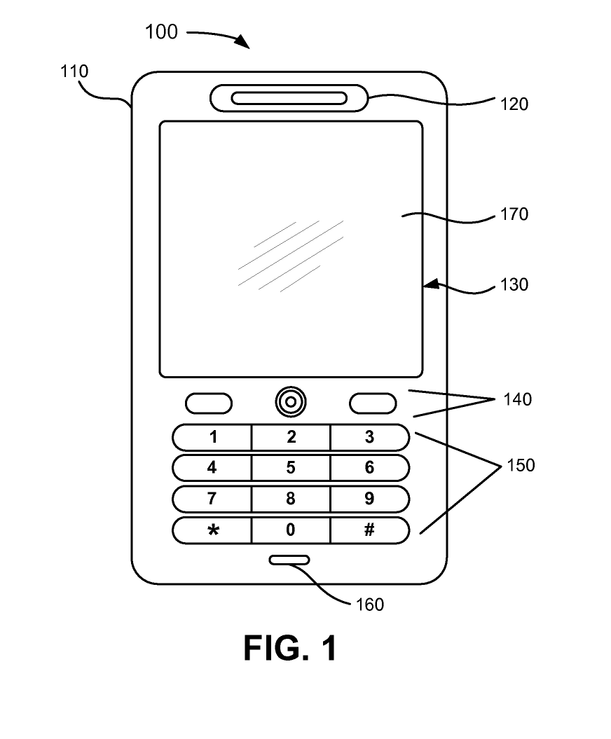

FIG. 1 is a diagram of an exemplary electronic device 100 in which methods and systems described herein may be implemented. Implementations are described herein in the context of a communication device having a touch screen. As used herein, the term “electronic device” may include a cellular radiotelephone; a Personal Communications System (PCS) terminal that may combine a cellular radiotelephone with data processing, facsimile and data communications capabilities; a PDA that can include a radiotelephone, pager, Internet/Intranet access, Web browser, organizer, calendar and/or a global positioning system (GPS) receiver; a gaming device; a media player device; a digital camera; a laptop or palmtop computer; or any other appliance that includes a touch-pad or touch-screen interface. Electronic device 100 may also include communication, media playing, recording, and storing capabilities.

Referring to FIG. 1, electronic device 100 may include a housing 110, a speaker 120, a display 130, control buttons 140, a keypad 150, a microphone 160, and a touch panel 170. Housing 110 may protect the components of electronic device 100 from outside elements. Speaker 120 may provide audible information to a user of electronic device 100. Speaker 120 may include any component capable of transducing an electrical signal to a corresponding sound wave. For example, a user may listen to music through speaker 120.

Display 130 may provide visual information to the user and serve—in conjunction with touch panel 170—as a user interface to detect user input. For example, display 130 may provide information and menu controls regarding incoming or outgoing telephone calls and/or incoming or outgoing electronic mail (e-mail), instant messages, short message service (SMS) messages, etc. Display 130 may further display information and controls regarding various applications executed by electronic device 100, such as a phone book/contact list program, a calendar, an organizer application, image manipulation applications, navigation/mapping applications, as well as other applications. For example, display 130 may present information and images associated with application menus that can be selected using multiple types of input commands. Display 130 may also display images associated with a camera, including pictures or videos taken by the camera and/or received by electronic device 100. Display 130 may also display video games being played by a user, downloaded content (e.g., news, images, or other information), etc.

Display 130 may include a device that can display signals generated by electronic device 100 as text or images on a screen (e.g., a liquid crystal display (LCD), cathode ray tube (CRT) display, organic light-emitting diode (OLED) display, surface-conduction electro-emitter display (SED), plasma display, field emission display (FED), bistable display, etc.). In certain implementations, display 130 may provide a high-resolution, active-matrix presentation suitable for the wide variety of applications and features associated with typical mobile devices.

Control buttons 140 may also be included to permit the user to interact with electronic device 100 to cause electronic device 100 to perform one or more operations, such as place a telephone call, play various media, access an application, etc. For example, control buttons 140 may include a dial button, hang up button, play button, etc. One of control buttons 140 may be a menu button that permits the user to view various settings on display 130. In one implementation, control keys 140 may be pushbuttons.

Keypad 150 may also be included to provide input to electronic device 100. Keypad 150 may include a standard telephone keypad. Keys on keypad 150 may perform multiple functions depending upon a particular application selected by the user. In one implementation, each key of keypad 150 may be, for example, a pushbutton. A user may utilize keypad 150 for entering information, such as text or a phone number, or activating a special function. Alternatively, keypad 150 may take the form of a keyboard that may facilitate the entry of alphanumeric text.

Microphone 160 may receive audible information from the user. Microphone 160 may include any component capable of transducing air pressure waves to a corresponding electrical signal.

As shown in FIG. 1, touch panel 170 may be integrated with and/or overlaid on display 130 to form a touch screen or a panel-enabled display that may function as a user input interface. For example, touch panel 170 may include a pressure-sensitive (e.g., resistive) touch panel that allows display 130 to be used as an input device. Generally, touch panel 170 may include any kind of technology that provides the ability to distinguish between changing surface areas of a body part or other deformable object as it is depressed on the surface of touch panel 170. Touch panel 170 may include the ability to identify movement of a body part or a pointing device as it moves on or near the surface of touch panel 170.

In one embodiment, touch panel 170 may include a resistive touch overlay having a top layer and a bottom layer separated by spaced insulators. The inside surface of each of the two layers may be coated with a material—such as a transparent metal oxide coating—that facilitates a gradient across the top and bottom layer when voltage is applied. Touching (e.g., pressing down) on the top layer may create electrical contact between the top and bottom layers, producing a closed circuit between the top and bottom layers and allowing identification of, for example, X and Y touch coordinates. The touch coordinates may be associated with a portion of display 130 having corresponding coordinates.

In other implementations, touch panel 170 may be smaller or larger than display 130. In still other implementations, touch panel 170 may not overlap the area of display 130, but instead may be located elsewhere on the surface of housing 110. In other embodiments, touch panel 170 may be divided into multiple touch panels, such as touch panels in strips around the edge of display 130. In still other implementations, front touch panel may cover display 130 and wrap around to at least a portion of one other surface of housing 110.

The components described above with respect to electronic device 100 are not limited to those described herein. Other components, such as connectivity ports, memory slots, and/or additional speakers, may be located on electronic device 100, including, for example, on a rear or side panel of housing 110.

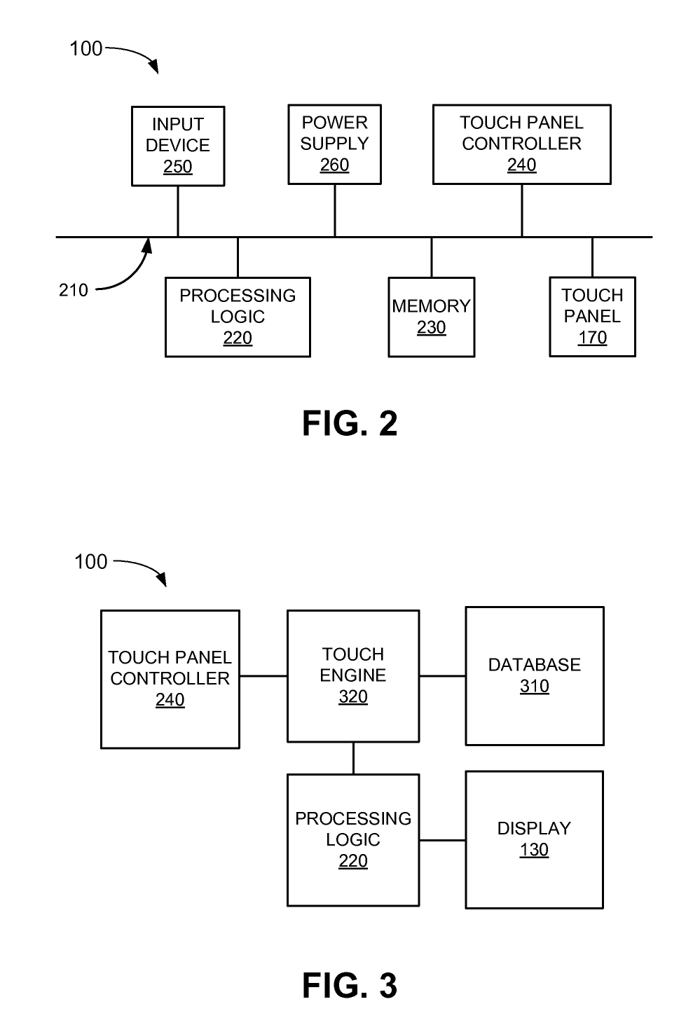

FIG. 2 is a block diagram illustrating components of the electronic device 100 according to an exemplary implementation. Electronic device 100 may include bus 210, processing logic 220, memory 230, touch panel 170, touch panel controller 240, input device 250, and power supply 260. Electronic device 100 may be configured in a number of other ways and may include other or different components. For example, electronic device 100 may include one or more output devices, modulators, demodulators, encoders, and/or decoders for processing data.

Bus 210 may permit communication among the components of electronic device 100. Processing logic 220 may include a processor, a microprocessor, an application specific integrated circuit (ASIC), a field programmable gate array (FPGA), or the like. Processing logic 220 may execute software instructions/programs or data structures to control operation of electronic device 100.

Memory 230 may include a random access memory (RAM) or another type of dynamic storage device that may store information and instructions for execution by processing logic 220; a read only memory (ROM) or another type of static storage device that may store static information and instructions for use by processing logic 220; a flash memory (e.g., an electrically erasable programmable read only memory (EEPROM)) device for storing information and instructions; and/or some other type of magnetic or optical recording medium and its corresponding drive. Memory 230 may also be used to store temporary variables or other intermediate information during execution of instructions by processing logic 220. Instructions used by processing logic 220 may also, or alternatively, be stored in another type of computer-readable medium accessible by processing logic 220. A computer-readable medium may include one or more physical or logical memory devices.

Touch panel 170 may accept touches from a user that can be converted to signals used by electronic device 100. Touch coordinates on touch panel 170 may be communicated to touch panel controller 240. Data from touch panel controller 240 may eventually be passed on to processing logic 220 for processing to, for example, associate the touch coordinates with information displayed on display 130.

Input device 250 may include one or more mechanisms in addition to touch panel 170 that permit a user to input information to electronic device 100, such as microphone 160, keypad 150, control buttons 140, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 250 may also be used to activate and/or deactivate touch panel 170.

Power supply 260 may include one or more batteries or another power source used to supply power to components of electronic device 100. Power supply 260 may also include control logic to control application of power from power supply 260 to one or more components of electronic device 100.

Electronic device 100 may provide a platform for a user to make and receive telephone calls, send and receive electronic mail, text messages, play various media, such as music files, video files, multi-media files, games, and execute various other applications. Electronic device 100 may perform these operations in response to processing logic 220 executing sequences of instructions contained in a computer-readable medium, such as memory 230. Such instructions may be read into memory 230 from another computer-readable medium. In alternative embodiments, hard-wired circuitry may be used in place of or in combination with software instructions to implement operations described herein. Thus, implementations described herein are not limited to any specific combination of hardware circuitry and software.

FIG. 3 is a functional block diagram of exemplary components that may be included in electronic device 100. As shown, electronic device 100 may include touch panel controller 240, database 310, touch engine 320, processing logic 220, and display 130. In other implementations, electronic device 100 may include fewer, additional, or different types of functional components than those illustrated in FIG. 3 (e.g., a web browser).

Touch panel controller 240 may identify touch coordinates from touch panel 170. Coordinates from touch panel controller 240 may be passed on to touch engine 320 to associate the touch coordinates with, for example, patterns of movement. Changes in the touch coordinates on touch panel 170 may be interpreted as, for example, a change in pressure applied to touch panel 170 or a corresponding motion.

Database 310 may be included in memory 230 (FIG. 2) and act as an information repository for touch engine 320. For example, touch engine 320 may associate changes in the touch coordinates on touch panel 170 with particular touch scenarios stored in database 310.

Touch engine 320 may include hardware and/or software for processing signals that are received at touch panel controller 240. More specifically, touch engine 320 may use the signal received from touch panel controller 240 to detect touches on touch panel 170 and a movement pattern associated with the touches so as to differentiate between types of touches. The touch detection, the movement pattern, and the touch location may be used to provide a variety of user input to electronic device 100.

Processing logic 220 may implement changes in display 130 based on signals from touch engine 320. For example, in response to signals that are received at touch panel controller 240, touch engine 320 may cause processing logic 220 to display a menu that is associated with an item previously displayed on the touch screen at one of the touch coordinates. In another example, touch engine 320 may cause processing logic 220 to accept and/or transmit information (e.g., a video, a picture, a piece of music, a link, text, a document, etc.) from and/or to a remote device (e.g., server).

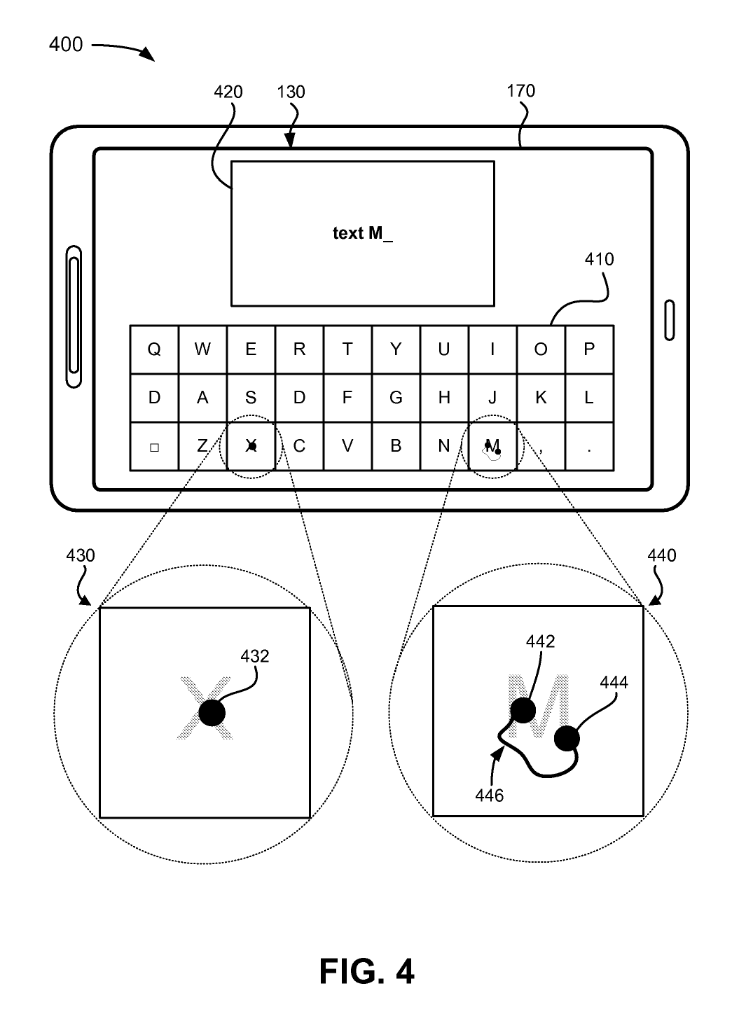

FIG. 4 is a diagram illustrating exemplary touch patterns on the surface of a touch screen display, such as display 130 and touch panel 170 on electronic device 400. Virtual keyboard 410 and text entry window 420 are shown on display 130. A user's touch (e.g., a finger or deformable stylus) on touch panel 170 may be distinguished based on the type of touch, such as a tap or a push. Implementations described herein may utilize the fact that a finger (or other deformable object) may not register the same quantity of coordinates during a discreet tap as during a push, when a somewhat higher force is applied.

When a user taps touch panel 170 quickly very few coordinates may be registered. The input generates coordinates that correspond to one or very few pixels close to each other. An enlarged view of the portion of touch panel 170 overlaying the “X” key 430 of virtual keyboard 410 indicates a point 432 that may represent a coordinate registered on touch panel 170 during a tap by, for example, a finger. The tap coordinate may generate a signal within electronic device 100 to display, for example, a lowercase “x” in text entry window 420.

Conversely, still referring to FIG. 4, an enlarged view of the portion of touch panel 170 overlaying the “M” key 440 of virtual keyboard 410 is shown. Points 442 and 444 and line 446 represent coordinates registered on touch panel 170 during a push by, for example, a finger. Generally, the average surface area of the finger may change as the finger is deformed during the push. Also, the finger placement may be somewhat inaccurate and may move during the time interval of the push. These variables during the push may result in multiple contact coordinates being registered on touch panel 170. Referring particularly to FIG. 4, a push in the vicinity of the “M” key 440 may register multiple coordinates, such as points 442 and 444 and line 446, over a short period of time. The multiple coordinates may be interpreted as a push and may be used to generate a signal within electronic device 100 to display, for example, an uppercase “M” in text entry window 420.

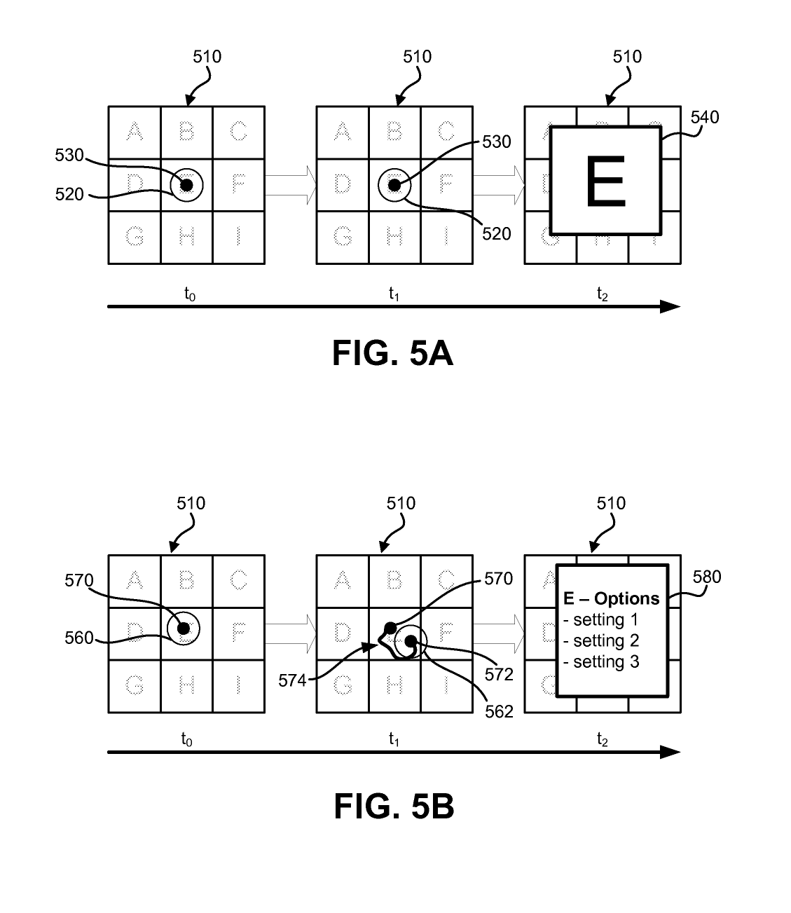

FIG. 5A shows an exemplary tap touch input on the surface of a display as a function of time, and FIG. 5B shows an exemplary push touch input on the surface of a display as a function of time. In both FIG. 5A and FIG. 5B, a representative menu 510 is shown providing menu items A, B, C, D, E, F, G, H, and I. Menu 510 may be shown, for example, on display 130 under touch panel 170 (which are not shown in FIGS. 5A and 5B). Menu 510 is shown as a function of time progressing from time t₀ to t₁ to t₂.

The scenario for a tap is shown in FIG. 5A. At time to, a finger (or other deformable object) “taps” touch panel 170 in the area overlaying the “E” icon, as denoted by circle 520 indicating the general finger position. Since the force is low, the user's finger is not significantly deformed. Thus, the tap generates a single set of coordinates 530 (one coordinate or a few coordinates close to each other) that may be identified by the touch panel controller (such as touch panel controller 240 of FIG. 2). The finger is released at time t₁, and the processing logic may interpret the input as a “tap” function and display the start of program “E” 540 at time t₂.

The scenario for a push is shown in FIG. 5B. At time to, a finger (or other deformable object) begins to “push” the touch panel 170 on the E-icon, as denoted by circle 560 indicating the general finger position. The initial contact generates a single set of coordinates 570 (one coordinate or a few coordinates close to each other) that may be identified by the touch panel controller. After t₀, the finger remains over the E-icon with some force larger than Fₜₕ, where Fₜₕ is a threshold force sufficient to cause deformation of the finger. During the time period of the “push” between t₀ and t₁, the finger may be deformed and slightly shift position to the area denoted by circle 562. A second set of coordinates 572 (one coordinate or a few coordinates close to each other) and a connecting line 574 may be registered by the touch panel controller. At time t₁, the finger may be released. Since the registered coordinates during the push input form line 574 between coordinates 570 and coordinates 572 with some certain shape, the touch input may be detected as a “push.” Thus, at time t₂, option list 580 may be shown.

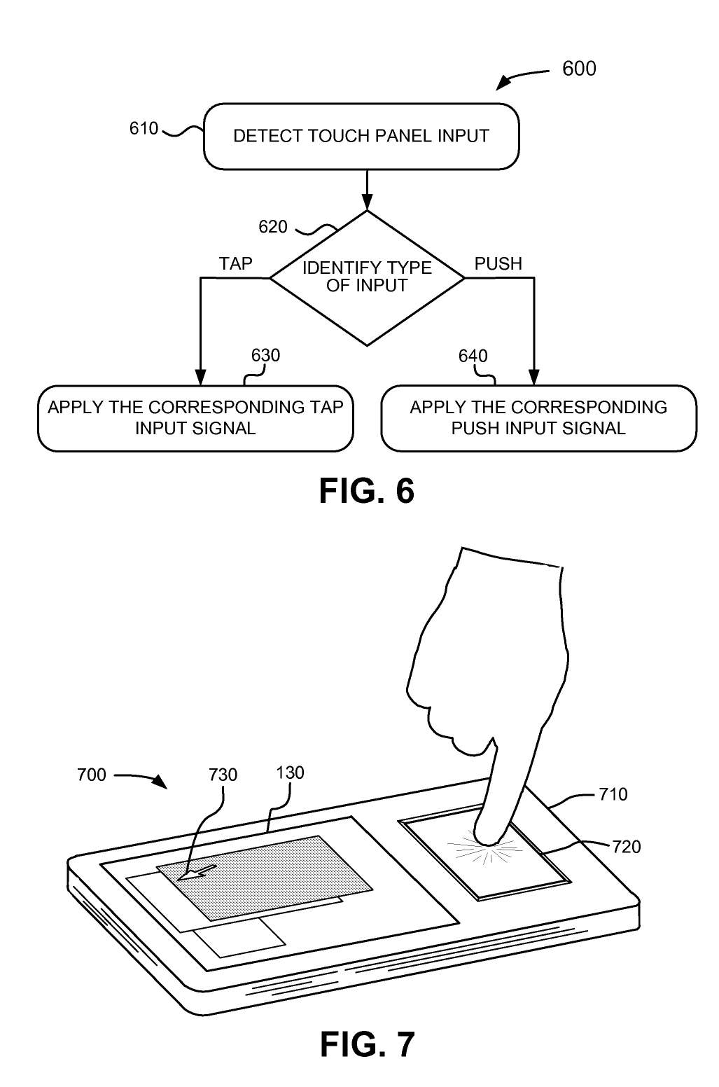

FIG. 6 is a flow diagram illustrating exemplary operations associated with electronic device 100. In block 610, an input to the touch panel may be detected. For example, electronic device 100 may detect a touch from a user. In block 620, the type of input may be identified. For example, electronic device 100 may identify the type of input (e.g., a tap or push) to determine the appropriate signal to send from processing logic 220 to other system components. If the touch input generates a single or small group of coordinates (as described in more detail with respect to FIG. 5A), a tap input may be identified. Thus, in block 630, the input signal corresponding to a tap may be applied. For example, electronic device 100 may apply a corresponding tap input signal. If the touch input generates a group of coordinates associated, for example, with a finger deformation (as described in more detail with respect to FIG. 5B), a push input may be identified. Thus, in block 640, the input signal corresponding to a push may be applied. For example, electronic device 100 may apply a corresponding push input signal.

FIG. 7 is a diagram of exemplary electronic device 700 in which methods and systems described herein may be implemented. Electronic device 700 may include housing 710, display 130, and touch pad 720. Other components, such as control buttons, a keypad, a microphone, a camera, connectivity ports, memory slots, and/or additional speakers, may be located on electronic device 700, including, for example, on a rear or side panel of housing 710. FIG. 7 illustrates touch panel 720 being separately located from display 130 on housing 710. Touch panel 720 may include any touch screen technology providing the ability to distinguish between changing surface areas of a body part or other deformable object as it is depressed on the surface of touch panel 720. User input on touch panel 720 may be associated with display 130 by, for example, movement and location of cursor 730. User input on touch pad may be in the form of the touch of a deformable object, such as a body part (e.g., a finger, as shown) or a deformable pointing device (e.g., a soft stylus, pen, etc.).

Touch panel 720 may be operatively connected with display 130. For example, touch panel 720 may include a pressure-sensitive (e.g., resistive) touch panel that allows display 130 to be used as an input device. Generally, touch panel 720 may include any kind of technology that provides the ability to distinguish between changing surface areas of a body part or other deformable object as it is depressed on the surface of touch panel 720. Touch panel 720 may include the ability to identify movement of a body part or pointing device as it moves on or near the surface of touch panel 720. As described above with respect to FIGS. 4, 5A and 5B, a touch may be identified as a tap or a push. In the arrangement of FIG. 7, the tap or push may correspond to the location of cursor 730 on display 130. The tap or push may each be interpreted by a different type of input signal.

### CONCLUSION

Implementations described herein may include a touch-sensitive interface for an electronic device that distinguishes between different kinds of touches, referred to herein as a tap and a push. By distinguishing between the different kinds of touches, different forms of user input may be supplied using a single touch-sensitive interface.

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been mainly described in the context of a communication device. These implementations, however, may be used with any type of device with a touch-sensitive display.

As another example, implementations have been described with respect to certain touch panel technology. Other technology may be used to accomplish certain implementations, such as different types of touch panel technologies, including but not limited to, surface acoustic wave technology, capacitive touch panels, infrared touch panels, strain gauge mounted panels, optical imaging touch screen technology, dispersive signal technology, acoustic pulse recognition, and/or total internal reflection technologies. In certain implementations, touch recognition systems may be located behind another surface so that deformation of a finger or other deformable object may occur on a surface other than that of the touch recognition system. Furthermore, in some implementations, multiple types of touch panel technology may be used within a single device.

Further, while a series of blocks has been described with respect to FIG. 6, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include hardware, such as a processor, microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A method performed by a device having a touch-sensitive display, the method comprising:
displaying an image on the touch-sensitive display;
detecting a touch on the touch-sensitive display;
determining a type of the touch;
associating a location of the touch with the image displayed on the touch-sensitive display; and
generating a command signal based on the type of touch and the location of the touch on the touch-sensitive display.

2. The method of claim 1, where the type of touch is one of a tap or a push.

3. The method of claim 1, where the touch-sensitive display includes a resistive touch panel.

4. The method of claim 1, where the touch is made by a deformable object.

5. The method of claim 1, where determining the type of touch comprises:
distinguishing between changing surface areas of a deformable object as the deformable object is depressed on the touch-sensitive display.

6. The method of claim 1, where determining the type of touch comprises:
comparing touch coordinates registered on the touch-sensitive display over a discreet time interval to distinguish a first type of the touch from a second type of the touch.

7. A device comprising:
a display to display information;
a touch-sensitive panel to identify a set of touch coordinates of a touch on the touch-sensitive panel;
processing logic to interpret the set of touch coordinates as one of a tap or a push;
processing logic to associate the touch coordinates with corresponding coordinates of the information on the display; and
processing logic to generate a command signal based on the interpreted set of touch coordinates and the corresponding coordinates of the information on the display.

8. The device of claim 7, where the touch-sensitive panel includes a resistive touch panel.

9. The device of claim 7, where the touch is made by a deformable object.

10. The device of claim 7, where the processing logic to interpret the set of touch coordinates as one of a tap or a push distinguishes between changing surface areas of a deformable object as the deformable object is depressed on the touch-sensitive panel.

11. The device of claim 7, where the processing logic to interpret the set of touch coordinates as one of a tap or a push compares touch coordinates registered on the touch-sensitive panel over a discreet time interval.

12. The device of claim 7, where the touch-sensitive panel is overlaid on the display.

13. The device of claim 7, further comprising:
a housing, where the touch-sensitive panel and the display are located on separate portions of the housing.

14. A computer-readable memory comprising computer-executable instructions, the computer-readable memory comprising:
one or more instructions for displaying an image on a touch-sensitive display;
one or more instructions for detecting a touch on the touch-sensitive display;
one or more instructions for identifying a location of the touch on the touch-sensitive display;
one or more instructions for identifying a type of the touch;
one or more instructions for associating the location of the touch and the type of the touch with the image displayed on the touch-sensitive display; and
one or more instructions for generating a command signal based on the type of the touch, the location of the touch on the touch-sensitive display, and the image on the touch-sensitive display.

15. The computer-readable memory of claim 14, where the type of touch is identified as one of a tap or a push.

16. The computer-readable memory of claim 14, where the touch-sensitive display includes a resistive touch panel.

17. The computer-readable memory of claim 14, where the touch is made by a deformable object.

18. The computer-readable memory of claim 14, where identifying a type of the touch comprises:
distinguishing between changing surface areas of a deformable object as the deformable object is depressed on the touch-sensitive display.

19. The computer-readable memory of claim 14, where identifying a type of the touch comprises:
comparing touch coordinates registered on the touch-sensitive display over a discreet time interval.

20. A device comprising:
means for displaying an image on a touch-sensitive display;
means for detecting a touch on the touch-sensitive display;
means for determining a kind of the touch;
means for identifying coordinates of the touch on the touch-sensitive display;
means for associating coordinates of the touch with the image displayed on the touch-sensitive display; and
means for generating a command signal based on the kind of touch and the coordinates of the touch on the touch-sensitive display.

21. A method performed by a device having a touch-sensitive panel comprising:
displaying an object on a screen;
identifying a first set of coordinates of a touch by a deformable object at a first time;
identifying a second set of coordinates of a touch by the deformable object at a second time;
associating the first set of coordinates and the second set of coordinates with the object on the screen; and
generating an input signal based on the object on the screen, the first set of coordinates and the second set of coordinates.
